(19) United States
(12) Patent Application Publication
(10) Pub. No.: US 2010/0057681 A1
(43) Pub. Date: Mar. 4, 2010

(54) Searching for Codes in Texts

(76) Inventor: Kenneth L. Willeford, Little River, SC (US)

Correspondence Address: CONNOLLY BOVE LODGE & HUTZ LLP, 1875 EYE STREET, N.W., SUITE 1100, WASHINGTON, DC, 20006, US

(21) Appl. No.: 12/200,974

(22) Filed: Aug. 29, 2008

(51) Int. Cl. G06F 7/10; H04L 9/06; G06F 17/30

(52) U.S. Cl. 707/3; 380/59; 707/E17.015

(57) ABSTRACT

Searching for codes hidden in texts, such as the Bible, may involve application of a cipher to the text and then searching the enciphered text for codes.

### FIELD OF THE INVENTION

Various embodiments of the invention may address search techniques for codes hidden in texts, for example, but not necessarily limited to, the Hebrew Bible (Torah).

### BACKGROUND OF THE INVENTION

An area of recent interest has been to search the Hebrew Bible (i.e., the Torah and/or other related texts, such as the prophets and writings) for “codes” hidden within the text. In this context, “codes” is used to refer to words, phrases, groups of words or phrases, etc., with related meaning or contextual significance that are embedded in the text. Such codes may, for example, be understood as predictions of future people, dates, or events (i.e., subsequent to the date of the text).

For example, in 1994, Witztum et al. published a paper (Witztum et al., “Equidistant Letter Sequences in the Book of Genesis,” Statistical Science, Vol. 9, No. 3, pp. 429-438, 1994; incorporated herein by reference) in which they presented their results of searching the Book of Genesis (in Hebrew) for specific people and dates (subsequent to the Torah), by searching for equidistant letter sequences (ELSs) corresponding to such people and dates. In particular, these researchers checked sequences of letters of length k, beginning at a point (letter) n (i.e., the “n^{th}” letter), with spacing d letters in between, to check if they resulted in codes being found. In other words, they obtained and reviewed letter sequences beginning with an n^{th} letter and defined as follows: n, n+d, n+2d, . . . ,n+(k−1)d (where each quantity in the sequence represents the number of a letter in the text (nth letter, n+d^{th} letter, etc.).

This technique may be made conceptually simpler, as discussed by Witztum et al., by creating two-dimensional matrices of letters. Then it is merely a matter of treating these similarly to common “word search” puzzles, to try and identify words hidden in the matrices.

As noted above, prior search techniques concentrate on identifying ELSs based on the plain text of the Torah. However, it may be possible to use other techniques to identify codes.

### SUMMARY OF EMBODIMENTS OF THE INVENTION

Various embodiments of the invention may be directed to the identification of codes in a text, for example, but not necessarily limited to, the Torah, by treating the text as if it, itself, is encrypted, and then searching for ELSs in the decrypted text. Various embodiments may comprise methods, codes obtained using the methods, and/or hardware and/or software embodying the methods.

### BRIEF DESCRIPTION OF THE DRAWINGS

Various embodiments of the invention will now be described in conjunction with the attached drawings, in which:

FIG. 1 shows a conceptual block diagram/flowchart according to an embodiment of the invention; and

FIG. 2 shows a conceptual block diagram of a system that may be used to implement all or portions of one or more embodiments of the invention.

### DETAILED DESCRIPTION OF VARIOUS EMBODIMENTS OF THE INVENTION

As discussed above, various embodiments of the present invention may address the use of ciphers in combination with searching for ELSs in Hebrew texts. In order to facilitate further discussion, it is convenient to use transliterations of the various Hebrew letters. Column 2 of the following table presents a transliteration of Hebrew letters, which corresponds to a modified version of what is known as the “Michigan Clairmont” scheme, which is commonly used for typing when a Hebrew keyboard is unavailable.

| | | Complementary | Complementary |
|---|---|---|---|
| Hebrew | Michigan | Hebrew | Michigan |
| [symbol] Aleph | A | [symbol] | T |
| [symbol] 12 Beth | B | [symbol] | S |
| [symbol] 12 Geemel | G | [symbol] | R |
| [symbol] 12 Dalet | D | [symbol] | Q |
| [symbol] 12 Heh | H | [symbol] | C |
| [symbol] 12 Vav | V | [symbol] | P |
| [symbol] 12 Zayeen | Z | [symbol] | O |
| [symbol] 12 Khet | X | [symbol] | F |
| [symbol] 12 Tet | E | [symbol] | N |
| [symbol] 12 Yod | Y | [symbol] | M |
| [symbol] 12 Kaf | K | [symbol] | L |
| [symbol] 12 Khaf | K | [symbol] | L |
| Sofeet | | | |
| [symbol] 12 Lamed | L | [symbol] | K |
| [symbol] 12 Mem | M | [symbol] | Y |
| [symbol] 12 Mem | M | [symbol] | Y |
| Sofeet | | | |
| [symbol] 12 Noon | N | [symbol] | E |
| [symbol] 12 Noon | N | [symbol] | E |
| Sofeet | | | |
| [symbol] 12 Samekh | F | [symbol] | X |
| [symbol] 12 Ayeen | O | [symbol] | Z |
| [symbol] 12 Peh | P | [symbol] | V |
| [symbol] 12 Feh | P | [symbol] | V |
| Sofeet | | | |
| [symbol] 12 Tsadee | C | [symbol] | H |
| [symbol] 12 Tsadee | C | [symbol] | H |
| Sofeet | | | |
| [symbol] Koof | Q | [symbol] | D |
| [symbol] Resh | R | [symbol] | G |
| [symbol] Sheen | S | [symbol] | B |
| [symbol] Tav | T | [symbol] | A |

In the table above, the first and third columns are complements of each other, as are the second and fourth columns. This complementation will be discussed further below.

As a threshold matter, one may ask why one might consider the use of ciphers in the Torah. However, one need only consult the text of various books of the Torah to find, at the very least, hints that all or portions of the Torah may be encrypted or contain encrypted text.

For example, a simple complementation cipher is suggested by at least Isaiah 46:10, which reads, “Declaring the end from the beginning and from ancient times the things that are not yet done, saying, My counsel shall stand, and I will do all my pleasure.” That is, the phrase, “declaring the end from the beginning,” may indicate that letters at the end of the alphabet are substituted for letters at the beginning, and vice versa. This passage may also be understood, i.e., based on the portion, “from ancient times the things that are not yet done,” as implying that “the end” that is declared from “the beginning” refers to future events, in other words, that the encrypted words or phrases may refer to people, events, etc., that may come to pass in the future.

Further support for a simple complementation cipher may also be found in the Book of Jeremiah. In Jeremiah 25:26, there is a word, which, in Hebrew, is spelled: Sheen, Sheen, Khaf Sofeet. This is a meaningless word and is generally translated in English to Sheshach (i.e., a mere English transliteration of the Hebrew word). When a complementation cipher, as shown in the above table, is used, the word in Hebrew becomes: Bet, Bet, Lamed, (Bavel), which means Babylon. The fact that Jeremiah used this cipher to encode this word may be confirmed by Jeremiah 51:41, where Sheshach and Babylon are used in parallel clauses. The same cipher appears to have been used by Jeremiah in Jeremiah 51:1 for the word spelled: Lamed, Bet, Koof, Mem, Yod. This again is meaningless and is translated in English to Leb Karnai (again, a transliteration of the Hebrew words). When complementation is applied to these letters, Kaf, Sheen, Dalet, Yod, Mem (Casdim) is produced, which may be translated as Chaldeans (a Biblical people).

Furthermore, in some circles, the Bible is referred to as being “The Living Word.” As such, one may surmise that it may be encoded similarly to how living things are “encoded.”

The code of living systems is DNA. The structure of DNA is a double helix with each strand of the helix made of a sugar-phosphate backbone on the outside and paired nucleotide bases on the inside. There are several nucleotide bases, including cytosine, thymine, uracil, adenine and guanine. Both DNA and the Bible have a primary sequence. The primary sequence of the Bible is the order of the letters. The primary sequence of DNA is the order of the nucleotide bases.

For example, the DNA double helix comprises two paired strands, in which each strand is complementary to the other strand. The pairing is consistent and repeatable. For example, guanine always pairs with cytosine, and cytosine always pairs with guanine. Likewise adenine and thymine always pair together. Therefore, a portion of DNA with a primary sequence of cytosine, adenine, guanine, adenine, thymine, cytosine would have complementary pairing in its complementary strand, namely the sequence, guanine, thymine, cytosine, thymine, adenine, guanine.

Furthermore, DNA replication uses a process of complementary base pairing in cell division to create identical copies of DNA for the daughter cells. DNA codes for characteristics of living systems but gene expression involves RNA. There are two steps in gene expression, transcription and translation. DNA serves as a template for RNA formation in transcription, and the process of translation then directs the assembly sequence of amino acids to form polypeptides from the RNA. All of these processes, DNA replication, transcription and translation, involve complementary base pairing. Complementary base pairing is a consistent feature of living systems.

Similar to the structure of the complementary DNA strands, such complementary base pairing is the assignment of a specific nucleotide base to pair with each of the bases on the DNA or RNA strand. These pairs are then chemically bonded. Each nucleotide base is paired with a complementary base in DNA and RNA.

Based on such motivations, one may then apply, for example, a substitution cipher in which letters are complemented, to the text of the Torah. The results of applying this substitution cipher, i.e., by substituting complementary letters for the original letters, to the Torah may be used to obtain a unique text, which in turn may be used to produce vast quantities of grouped, encoded, and related words by finding ELSs in contextually significant locations.

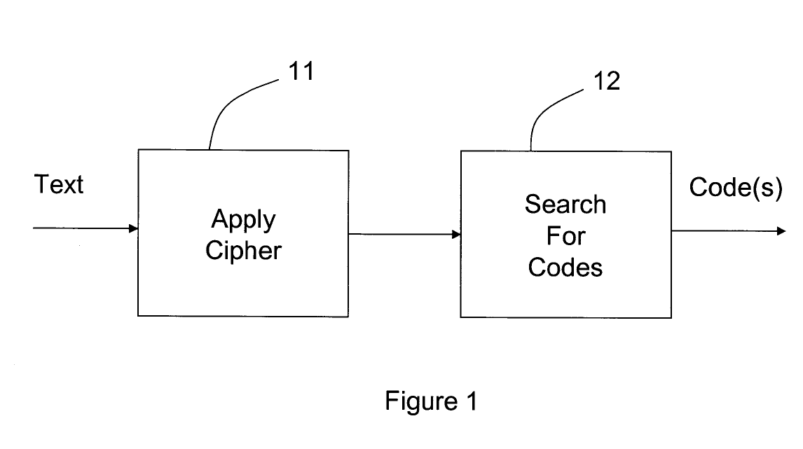

In view of the above, various embodiments of the invention may be illustrated by the process suggested by FIG. 1. As shown in FIG. 1, text, such as, but not limited to, all or portions of the Torah, may be input, and a cipher may be applied 11. The application of the cipher in block 11 may be preceded by transliteration (not shown), if the text is non-English and/or if the process of FIG. 1 is not equipped to handle the language of the text. In block 11, the applied cipher may be a substitution cipher, and the substitution cipher may be a complementation cipher, as described above. For example, in the table shown above, for each Hebrew letter in the text, a complementary Hebrew letter may be substituted. As a further example of this, if the portion of the text reads “SSK,” the output of this process may be “BBL” (using the modified Michigan Clairmont transliteration shown above). Similarly, “BRVK” may result in an output of “SGPL.”

The cipher applied in block 11 may be applied without respect to word boundaries, grammar, or punctuation. Therefore, a block of text may read, for example, “MCVT XLYCH BSLVSH DYNYM”, and may be treated as “MCVTXLYCHBSLVSHDYNYM”, similarly giving rise to complemented text without spacing at the output of block 11, if the complementation cipher is used. As noted above, however, embodiments of the invention may use other types of ciphers, and the complementation cipher is used as an example.

The output of block 11 may then be searched for codes 12. In block 12, as an example, the output of block 11 may be searched for ESLs; however, the invention is not necessarily to be limited to searching for ESLs, and other types of searches may also be applied, as may be desired. The output of block 12 may comprise one or more codes found during the search (or no codes, if no codes are found in the output of block 11).

As noted above, a substitution cipher, for example, a complementation cipher, may be applied, but the invention is not thus limited. Other types of ciphers may similarly be applied. Examples of such ciphers may include computation-based ciphers (e.g., based on a seed number/sequence), shifting ciphers (e.g., substitution by shifting the letters of the alphabet), and/or pseudo-random ciphers (e.g., where a pseudo-random sequence is applied to (e.g., combined with) the text).

Additionally, the above table shows one way of transliterating, in which the non-final and final forms of the same Hebrew letter are treated as a single letter. However, they may, alternatively, be treated as separate letters, which, in the complementation cipher, may result in different substitutions or different cipher results for non-substitution ciphers.

Furthermore, searches for sequences other than ELSs may be carried out in block 12. For example, non-equidistant length sequences may be searched for. An example of such sequences may be a sequence in which the letters are spaced by regularly increasing intervals (e.g., nth letter, n+1^{st} letter, n+1+2^{nd} letter, n+1+2+3^{rd} letter, etc.).

Additionally, the above methods may be applicable to texts in languages other than Hebrew (e.g., Aramaic, Greek, et al.) and/or to non-biblical texts.

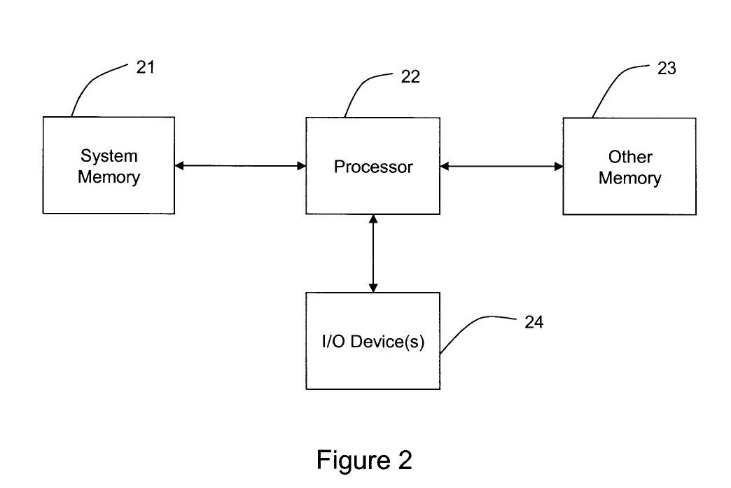

As noted above, various embodiments of the invention may comprise hardware, software, and/or firmware. FIG. 2 shows an exemplary system that may be used to implement various forms and/or portions of embodiments of the invention. Such a computing system may include one or more processors 22, which may be coupled to one or more system memories 21. Such system memory 21 may include, for example, RAM, ROM, or other such machine-readable media, and system memory 21 may be used to incorporate, for example, a basic I/O system (BIOS), operating system, instructions for execution by processor 22, etc. The system may also include further memory 23, such as additional RAM, ROM, hard disk drives, or other processor-readable media. Processor 22 may also be coupled to at least one input/output (I/O) interface 24. I/O interface 24 may include one or more user interfaces, as well as readers for various types of storage media and/or connections to one or more communication networks (e.g., communication interfaces and/or modems), by means of which, for example, software code may be obtained (e.g., via downloading). Furthermore, other devices/media may also be coupled to and/or interact with the system shown in FIG. 2.

Applicant has attempted to disclose all embodiments and applications of the disclosed subject matter that could be reasonably foreseen. However, there may be unforeseeable, insubstantial modifications that remain as equivalents. While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

I claim:

1. A method of obtaining at least one code in a text, the method comprising:
applying a cipher to said text to obtain enciphered text; and
searching the enciphered text for one or more codes and outputting at least one of said codes.

2. The method of claim 1, wherein said searching comprises:
searching the enciphered text for one or more equidistant length sequences.

3. The method of claim 1, wherein said cipher comprises a substitution cipher.

4. The method of claim 1, wherein said cipher comprises complementation of letters of said text.

5. The method of claim 1, wherein said text comprises one or more portions of the Bible.

6. The method of claim 1, further comprising:
transliterating the letters of said text prior to said applying a cipher.

7. The method of claim 1, further comprising:
downloading software code to implement said applying a cipher and said searching the enciphered text.

8. The method of claim 1, wherein said text is a non-English text.

9. A code obtained from a text using a method comprising:
applying a cipher to said text to obtain enciphered text; and
searching the enciphered text for one or more codes.

10. A processor-readable medium containing software code that, when executed by a processor, implement a method of obtaining at least one code from a text, the method comprising:
applying a cipher to said text to obtain enciphered text; and
searching the enciphered text for one or more codes and outputting at least one of said codes.

11. The medium of claim 10, wherein said searching comprises:
searching the enciphered text for one or more equidistant length sequences.

12. The medium of claim 10, wherein said cipher comprises a substitution cipher.

13. The medium of claim 10, wherein said cipher comprises complementation of letters of said text.

14. The medium of claim 10, wherein said text comprises one or more portions of the Bible.

15. The medium of claim 10, wherein the method further comprises:
transliterating the letters of said text prior to said applying a cipher.

16. The method of claim 10, wherein said text is a non-English text.
